(19) United States
(12) Patent Application Publication
(10) Pub. No.: US 2023/0374257 A1
(43) Pub. Date: Nov. 23, 2023

(54) METHOD OF PRODUCING MAGNETIC POWDER-CONTAINING RESIN COMPOSITION

(71) Applicant: NICHIA CORPORATION, Anan-shi (JP)

(72) Inventors: Shuichi TADA, Komatsushima-shi (JP); Takashi ASADA, Anan-shi (JP); Masahiro ABE, Tokushima-shi (JP)

(73) Assignee: NICHIA CORPORATION, Anan-shi (JP)

(21) Appl. No.: 18/318,924

(22) Filed: May 17, 2023

(30) Foreign Application Priority Data
May 17, 2022 (JP) 2022-080979

(51) Int. Cl. C08K 3/08; C08L 63/00; H01F 1/059; H01F 1/06; C08G 59/50

(52) U.S. Cl. CPC C08K 3/08; C08L 63/00; H01F 1/059; H01F 1/06; C08G 59/5033; C08K 2201/01; C08K 2201/005

(57) ABSTRACT

A method, including: preparing at least one magnetic powder having an average particle size that is at least 1 μm but not more than 10 μm, at least one thermosetting resin, and at least one curing agent, wherein at least one of the thermosetting resin and the curing agent includes at least one monomer having a melting point that is higher than 70° C. but not higher than 140° C., and wherein an amount of the monomer having the melting point that is higher than 70° C. but not higher than 140° C. is at least 33% by volume but not more than 100% by volume of a combined amount of the thermosetting resin and the curing agent; and obtaining a magnetic powder-containing resin composition by kneading the magnetic powder, the thermosetting resin, and the curing agent at a temperature of higher than 70° C. but not higher than 140° C. and then lowering the temperature.

### CROSS-REFERENCE TO RELATED PATENT APPLICATION

This application claims priority to Japanese Patent Application No. 2022-080979, filed on May 17, 2022. The disclosure of Japanese Patent Application No. 2022-080979 is hereby incorporated by reference in its entirety.

### BACKGROUND

The present disclosure relates to a method of producing a magnetic powder-containing resin composition.

In order to produce a bonded magnet with high heat resistance, it is important to select an optimum combination of a resin binder and magnetic powder. For example, when magnetic powder with low heat resistance, such as NdFeB-based magnetic powder or SmFeN-based magnetic powder, is used, the use of a thermoplastic resin with a high melting point, such as polyphenylene sulfide, aromatic nylon, or nylon 66, as a resin binder can increase the molding temperature, resulting in a bonded magnet having an insufficient coercive force. In contrast, the use of a thermosetting resin, which is moldable at a relatively low temperature, can result in a high coercive force, even when it is combined with magnetic powder with low heat resistance.

Moreover, transfer molding may be performed to produce a molded product having a complex shape from a thermosetting resin. In transfer molding, a kneaded mixture containing magnetic powder and a resin composition may be transferred to a mold cavity prior to heat-curing.

A kneaded mixture of bonded magnet materials for transfer molding may be prepared by kneading a resin composition dissolved in an organic solvent with magnetic powder and then removing the organic solvent, or by heating and kneading a resin composition and magnetic powder in a kneading apparatus. In view of an increase in production cost and concern for residues of the organic solvent in the molded product, etc., the heating and kneading method is preferred. However, if the resin composition has a high viscosity during kneading, this may lead to a decrease in kneading stability or a reduction in the efficiency of filling the mold cavity.

Bonded magnets to be prepared include bonded magnets formed of magnetic powder having a particle size as small as at least 1 μm but not more than 10 μm. For example, a SmFeN-based anisotropic magnetic material is magnetic powder combining a high saturation magnetization and a high anisotropic magnetic field that exceeds 260 kOe when it has an average particle size that is about 3 μm, and may be highly filled to produce a high performance bonded magnet.

As a kneaded mixture containing magnetic powder and a resin composition, JP 2020-163833 A discloses a resin molding material for transfer molding which contains SmFeN-based magnetic powder, an epoxy resin that is solid at 23° C., and a curing agent.

WO 2019/198237 discloses a method of producing a composite material by transfer molding of a compound containing a thermosetting resin and metal powder.

### SUMMARY

In the production of a magnetic powder/resin composite material for transfer molding, the deterioration of kneading stability due to an increase in viscosity is more significant when it contains magnetic powder having a smaller average particle size. The reason for the viscosity increases during kneading of magnetic powder and a resin composition is assumed to be that heat-curing may occur between a resin binder and a part of a curing agent due to shear heat generated by strong interparticle friction of small particles during kneading. Moreover, to obtain a bonded magnet with excellent magnetic force, it is necessary to increase the magnetic powder filling ratio. However, the higher the filling ratio, the larger the aforementioned shear heat. Consequently, the kneading stability of the composite and the efficiency of filling the mold cavity are contradictory to the magnetic properties of the resulting magnet. Nevertheless, no satisfactory bonded magnet compound for transfer molding has been designed to reduce the viscosity increase due to fine magnetic powder particles and to highly fill the compound with the magnetic powder. Embodiments of the present disclosure aim to provide a method of producing a magnetic powder-containing resin composition which has high kneading stability, suits for transfer molding, and enables the production of a bonded magnet with excellent magnetic properties.

Exemplary embodiments of the present disclosure relate to a method of producing a magnetic powder-containing resin composition, the method including: preparing at least one magnetic powder having an average particle size that is at least 1 μm but not more than 10 μm, at least one thermosetting resin, and at least one curing agent, wherein at least one of the thermosetting resin and the curing agent includes at least one monomer having a melting point that is higher than 70° C. but not higher than 140° C., and wherein an amount of the monomer having the melting point that is higher than 70° C. but not higher than 140° C. is at least 33% by volume but not more than 100% by volume of a combined amount of the thermosetting resin and the curing agent; and obtaining the magnetic powder-containing resin composition by kneading the magnetic powder, the thermosetting resin, and the curing agent at a temperature of higher than 70° C. but not higher than 140° C. and then lowering the temperature.

Exemplary embodiments of the present disclosure also relate to a method of producing a tablet for transfer molding, the method including: obtaining a magnetic powder-containing resin composition by the above-described method; obtaining a ground product by grinding the magnetic powder-containing resin composition; and compressing the ground product.

Exemplary embodiments of the present disclosure also relate to a method of producing a bonded magnet, the method including: obtaining a tablet for transfer molding by the above-described method; filling a mold with the tablet for transfer molding by softening the tablet; and heat-curing the filled tablet while applying magnetism in the mold.

The above embodiments can provide a method of producing a magnetic powder-containing resin composition which has high stability during kneading of magnetic powder and a resin component, suits for transfer molding, and enables the production of a bonded magnet with excellent magnetic properties.

### BRIEF DESCRIPTION OF DRAWINGS

FIG. 1 shows examples of the relationships between the exposure temperature and the irreversible flux loss of various bonded magnets.

FIG. 2 shows examples of the relationships between the exposure time at 150° C. and the irreversible flux loss of various bonded magnets.

### DETAILED DESCRIPTION

Embodiments of the present disclosure are described in detail below. The following embodiments, however, are intended as examples to embody the technical idea of the present invention and are not intended to limit the scope of the present invention to the following embodiments. As used herein, the term “step” encompasses not only an independent step but also a step that may not be clearly distinguished from other steps, as long as a desired object of the step is achieved. Moreover, numerical ranges indicated using “to” refer to ranges including the numerical values before and after “to” as the minimum and maximum, respectively.

### Method of Producing Magnetic Powder-Containing Resin Composition

A method of producing a magnetic powder-containing resin composition according to the present embodiments includes: preparing at least one magnetic powder having an average particle size that is at least 1 μm but not more than 10 μm, at least one thermosetting resin, and at least one curing agent, wherein the combined amount of thermosetting monomers having a melting point that is higher than 70° C. but not higher than 140° C. and curing agent monomers having a melting point that is higher than 70° C. but not higher than 140° C. is at least 33% by volume but not more than 100% by volume of the combined amount of the thermosetting resin and the curing agent; and obtaining a magnetic powder-containing resin composition by kneading the magnetic powder, the thermosetting resin, and the curing agent at a temperature of higher than 70° C. but not higher than 140° C. and then lowering the temperature.

### Magnetic Powder

The material of the magnetic powder is not limited. Examples of the material include SmFeN-based, NdFeB-based, and SmCo-based rare earth magnetic materials. In view of magnetic properties such as heat resistance and coercive force, as well as the fact that rare metals such as Dy, Tb, and Co are not required, SmFeN-based magnetic powder is preferred among these. SmFeN-based magnetic powder may be a nitride having a Th₂Zn₁₇-type crystal structure and containing the rare earth metal samarium (Sm), iron (Fe), and nitrogen (N), as represented by the general formula: SmₓFe_{100-x-y}N_{y}, preferably wherein x is at least 8.1 at % but not more than 10 at %; y is at least 13.5 at % but not more than 13.9 at %; and the balance is mainly Fe.

SmFeN-based magnetic powder may be produced by the method disclosed in JP H11-189811 A. NdFeB-based magnetic powder may be produced by the HDDR method disclosed in WO 2003/85147. SmCo-based magnetic powder may be produced by the method disclosed in JP H08-260083 A.

These types of magnetic powder may be used alone or in combinations of two or more. When two or more types of magnetic powder are used in combination, the percentage of SmFeN-based magnetic powder based on the total magnetic powder is preferably not lower than 50% by mass, more preferably not lower than 60% by mass, still more preferably not lower than 70% by mass. The percentage of SmFeN-based magnetic powder based on the total magnetic powder may also be not higher than 100% by mass. When the percentage of SmFeN-based magnetic powder based on the total magnetic powder is within the range indicated above, the resulting bonded magnet tends to have a higher coercive force.

For example, the magnetic powder to be used may be surface-treated with a silane coupling agent by the method described in JP 2017-43804 A.

The average particle size of the magnetic powder used is at least 1 μm but not more than 10 μm. In view of magnetic properties, the average particle size is preferably at least 1 μm but not more than 6 μm, more preferably at least 2 μm but not more than 4 μm. When the average particle size of the magnetic powder is not more than 10 μm, a reduction of the coercive force of the magnetic powder tends to be reduced. Also, when the average particle size of the magnetic powder is less than 1 μm, the magnetic powder tends to be susceptible to oxidation degradation when exposed to the atmosphere, resulting in lower coercive force. Herein, the average particle size refers to the volume average particle size (volume median diameter, VMD) determined by a laser diffraction particle size distribution analyzer (HELOS, Japan Laser Corporation), unless otherwise stated. Moreover, when two or more types of magnetic powder are used in combination, the average particle size is determined from all types of the powder. When the average particle size of the magnetic powder is within the range indicated above, the magnetic powder used is more effective in reducing an increase in the viscosity of the kneaded mixture with the resin while having high magnetic properties. Thus, a better bonded magnet can be produced.

Moreover, the D50 of the magnetic powder is preferably at least 1 μm but not more than 10 μm, more preferably at least 1 μm but not more than 6 μm, still more preferably at least 2 μm but not more than 4 μm. The D50 is determined by measuring a cumulative particle size distribution by volume using a laser diffraction particle size distribution analyzer (HELOS, Japan Laser Corporation) and is defined as the particle size corresponding to the 50th percentile of the cumulative undersize particle size distribution. When two or more types of magnetic powder are used in combination, the D50 is the particle size determined from all types of the magnetic powder.

### SmFeN-Based Magnetic Powder

When the magnetic powder used is SmFeN-based magnetic powder, the SmFeN-based magnetic powder is preferably anisotropic. Anisotropic SmFeN-based magnetic powder tends to provide a higher remanence, resulting in a bonded magnet having better magnetic properties than a bonded magnet with anisotropic SmFeN-based magnetic powder. Moreover, the SmFeN-based magnetic powder preferably has a surface coated with a phosphate to improve the coercive force and heat resistance. The phosphate content of the SmFeN-based magnetic powder is preferably higher than 0.5% by mass but not higher than 4.5% by mass, more preferably at least 0.8% by mass but not higher than 2% by mass, still more preferably at least 0.9% by mass but not higher than 1.5% by mass. When the phosphate content is not higher than 0.5% by mass, the effect of the phosphate coating tends to be reduced. When the phosphate content is higher than 4.5% by mass, the phosphate-coated SmFeN-based magnetic powder particles tend to aggregate to reduce the coercive force. Here, the phosphate content of the magnetic powder is measured by ICP atomic emission spectroscopy (ICP-AES) and converted from the measured P content to a PO₄ molecule content.

### Phosphate Treatment Step

For example, the phosphate-coated SmFeN-based magnetic powder may be obtained by adding an inorganic acid to a slurry containing SmFeN-based magnetic powder, water, and a phosphate compound. The phosphate-coated SmFeN-based magnetic powder can be formed by reacting the metal component (for example, iron or samarium) of the SmFeN-based magnetic powder with the phosphate component of the phosphate compound to precipitate a phosphate (for example, iron phosphate or samarium phosphate) on the surface of the SmFeN-based magnetic powder. It is believed that the use of water as a solvent allows the precipitated phosphate to have a smaller particle size than when the solvent is an organic solvent, and the resulting phosphate-coated SmFeN-based magnetic powder has a dense coating and thus enhanced intrinsic coercive force (iHc).

The slurry containing SmFeN-based magnetic powder, water, and a phosphate compound may be prepared by any method. For example, the slurry may be obtained by mixing SmFeN-based magnetic powder with an aqueous phosphate solution containing a phosphate compound and water as a solvent. The amount of the SmFeN-based magnetic powder in the slurry is, for example, at least 1% by mass but not more than 50% by mass, but in view of productivity, it is preferably at least 5% by mass but not more than 20% by mass. The amount of the phosphate component (PO₄) in the slurry as calculated as PO₄ is, for example, at least 0.01% by mass but not more than 10% by mass, but in view of reactivity between the metal component and the phosphate component and productivity, it is preferably at least 0.05% by mass but not more than 5% by mass.

The aqueous phosphate solution may be prepared by mixing a phosphate compound with water. Examples of the phosphate compound include orthophosphoric acid, sodium dihydrogen phosphate, sodium monohydrogen phosphate, ammonium dihydrogen phosphate, ammonium monohydrogen phosphate, zinc phosphate, calcium phosphate, and other phosphates, hypophosphorous acid and hypophosphites, pyrophosphoric acid, polyphosphoric acid, and other inorganic phosphoric acids, and organic phosphoric acids, and salts thereof. These may be used alone or in combinations of two or more. Moreover, to enhance the water resistance and corrosion resistance of the coating and the magnetic properties of the magnetic powder, additives may be used including, for example, oxoacid salts such as molybdates, tungstates, vanadates, and chromates; oxidizing agents such as sodium nitrate and sodium nitrite; and chelating agents such as EDTA.

The phosphate (calculated as PO₄) concentration in the aqueous phosphate solution is, for example, at least 5% by mass but not more than 50% by mass, but in view of the solubility and storage stability of the phosphate compound and ease of chemical treatment, it is preferably at least 10% by mass but not more than 30% by mass. The pH of the aqueous phosphate solution is, for example, at least 1 but not higher than 4.5, but it is preferably at least 1.5 but not higher than 4 in order to easily control the precipitation rate of the phosphate. The pH may be adjusted using dilute hydrochloric acid, dilute sulfuric acid, or the like.

In the phosphate treatment step, an inorganic acid is preferably added to adjust the pH of the slurry to at least 1 but not higher than 4.5, more preferably at least 1.6 but not higher than 3.9, still more preferably at least 2 but not higher than 3. When the pH is adjusted within the range indicated above, it is believed that the amount of the precipitated phosphate may be increased as compared to when the pH is not adjusted, and the resulting phosphate-coated SmFeN-based magnetic powder has a thick coating and thus enhanced coercive force (iHc). When the pH is lower than 1, aggregation of the phosphate-coated SmFeN-based magnetic powder particles tends to occur starting from the locally highly precipitated phosphate, resulting in lower coercive force. When the pH is higher than 4.5, the amount of the precipitated phosphate tends to decrease, resulting in an insufficient coating and thus lower coercive force. Examples of the inorganic acid to be added include hydrochloric acid, nitric acid, sulfuric acid, boric acid, and hydrofluoric acid. In the phosphate treatment step, the inorganic acid may be added as needed to adjust the pH within the above-described range. Although the inorganic acid is used in view of liquid waste disposal, an organic acid may be used together depending on the purpose. Examples of the organic acid include acetic acid, formic acid, and tartaric acid.

The adjustment of the pH of the slurry containing SmFeN-based magnetic powder, water, and a phosphate compound within the range of at least 1 but not higher than 4.5 is preferably performed for at least 10 minutes. To reduce the thin parts of the coating, the adjustment is more preferably performed for at least 30 minutes. In the pH maintenance, as the pH initially increases rapidly, the inorganic acid for pH control needs to be introduced at short intervals. Then, as the coating proceeds, the pH changes gently, and therefore the inorganic acid may be introduced at longer intervals, which allows one to determine the end point of the reaction.

### Oxidation Step after Phosphate Treatment

The phosphate-coated SmFeN-based magnetic powder may optionally be oxidized. When the phosphate-coated SmFeN-based magnetic powder is oxidized, the surface of the base material SmFeN-based magnetic powder coated with a phosphate is oxidized to form an iron oxide layer which enhances the oxidation resistance of the phosphate-coated SmFeN-based magnetic powder. Moreover, the oxidation can inhibit undesirable oxidation-reduction reaction, decomposition reaction, and alteration from occurring on the surface of the SmFeN particles when the phosphate-coated SmFeN-based magnetic powder is exposed to a high temperature in the production of a bonded magnet, resulting in a magnet having high magnetic properties, particularly a high intrinsic coercive force (iHc).

For example, the oxidation may be carried out by subjecting the phosphate-treated SmFeN-based magnetic powder to heat treatment in an oxygen-containing atmosphere. The reaction atmosphere preferably contains oxygen in an inert gas such as nitrogen or argon. The oxygen concentration is preferably at least 3% but not more than 21%, more preferably at least 3.5% but not more than 10%. During the oxidation reaction, gas exchange is preferably performed at a flow rate of at least 2 L/min but not higher than 10 L/min per 1 kg of the magnetic powder.

The temperature during the oxidation is preferably at least 150° C. but not higher than 250° C., more preferably at least 170° C. but not higher than 230° C. When the temperature is lower than 150° C., the formation of an iron oxide layer tends to be insufficient, resulting in lower resistance to oxidation. When the temperature is higher than 250° C., the formation of an iron oxide layer tends to be excessive, resulting in lower coercive force. The reaction time is preferably at least three hours but not more than 10 hours.

The phosphate-coated SmFeN-based magnetic powder preferably has a carbon content of not higher than 800 ppm, more preferably not higher than 600 ppm. The carbon content indicates the amount of organic impurities in the phosphate. When the phosphate-coated SmFeN-based magnetic powder having a carbon content higher than 800 ppm is exposed to a high temperature in the production of a bonded magnet, the organic impurities tend to be decomposed to cause defects in the coating, resulting in lower coercive force. Here, the carbon content can be measured by a TOC method.

### Silica Treatment Step

The phosphate-treated SmFeN-based magnetic powder may optionally be subjected to a silica treatment. The formation of a silica thin film on the magnetic powder enhances oxidation resistance. The silica thin film may be formed, for example, by mixing an alkyl silicate, the phosphate-coated SmFeN-based magnetic powder, and an alkali solution.

### Silane Coupling Treatment Step

The silica-treated magnetic powder may be further treated with a silane coupling agent. When the magnetic powder provided with a silica thin film is subjected to a silane coupling treatment, a coupling agent film is formed on the silica thin film, which improves the magnetic properties of the magnetic powder as well as wettability between the magnetic powder and the resin and magnet strength. Any silane coupling agent may be used and may be selected depending on the resin type. Examples of the silane coupling agent include γ-(2-aminoethyl)aminopropyltrimethoxysilane, γ-(2-aminoethyl)aminopropylmethyldimethoxysilane, γ-methacryloxypropyltrimethoxysilane, γ-methacryloxypropylmethyldimethoxysilane, N-β-(N-vinylbenzylaminoethyl)-γ-aminopropyltrimethoxysilane hydrochloride, γ-glycidoxypropyltrimethoxysilane, γ-mercaptopropyltrimethoxysilane, methyltrimethoxysilane, methyltriethoxysilane, vinyltriacetoxysilane, γ-chloropropyltrimethoxysilane, hexamethylenedisilazane, γ-anilinopropyltrimethoxysilane, vinyltrimethoxysilane, octadecyl[3-(trimethoxysilyl)propyl]ammonium chloride, γ-chloropropylmethyldimethoxysilane, γ-mercaptopropylmethyldimethoxysilane, methyltrichlorosilane, dimethyldichlorosilane, trimethylchlorosilane, vinyltrichlorosilane, vinyltris(β-methoxyethoxy)silane, vinyltriethoxysilane, β-(3,4-epoxycyclohexyl)ethyltrimethoxysilane, γ-glycidoxypropylmethyldiethoxysilane, γ-glycidoxypropyltriethoxysilane, γ-glycidoxypropyltrimethoxysilane, N-β-(aminoethyl)-γ-aminopropyltrimethoxysilane, N-β-(aminoethyl)-γ-aminopropylmethyldimethoxysilane, γ-aminopropyltriethoxysilane, N-phenyl-γ-aminopropyltrimethoxysilane, ureidopropyltriethoxysilane, γ-isocyanatopropyltriethoxysilane, polyethoxydimethylsiloxane, polyethoxymethylsiloxane, bis(trimethoxysilylpropyl)amine, bis(3-triethoxysilylpropyl)tetrasulfane, γ-isocyanatopropyltrimethoxysilane, vinylmethyldimethoxysilane, 1,3,5-N-tris(3-trimethoxysilylpropyl)i socyanurate, t-butyl carbamate trialkoxysilane, N-(1,3-dimethylbutylidene)-3-(triethoxysilyl)-1-propaneamine, octyltriethoxysilane, octyltrimethoxysilane, decyltriethoxysilane, decyltrimethoxysilane, octadecyltriethoxysilane, and octadecyltrimethoxysilane. These silane coupling agents may be used alone or in combinations of two or more. The amount of the silane coupling agent added per 100 parts by mass of the magnetic powder is preferably at least 0.2 parts by mass but not more than 0.8 parts by mass, more preferably at least 0.25 parts by mass but not more than 0.6 parts by mass. When the amount is less than 0.2 parts by mass, the effect of the silane coupling agent tends to be small. When the amount is more than 0.8 parts by mass, the magnetic properties of the magnetic powder or magnet tend to decrease due to aggregation of the magnetic powder.

The SmFeN-based magnetic powder obtained after the phosphate treatment step, oxidation step, silica treatment, or silane coupling treatment may be filtered, dehydrated, and dried in a usual manner.

The particle size D10 of the SmFeN-based magnetic powder is preferably at least 1 μm but not more than 3 μm, more preferably at least 1.5 μm but not more than 2.5 μm. When the particle size D10 of the SmFeN-based magnetic powder is less than 1 μm, the magnetic powder may be susceptible to oxidation degradation and the resulting bonded magnet may have a lower coercive force; further, as the viscosity of the kneaded mixture increases, the amount of the magnetic powder filled in the bonded magnet may be reduced, resulting in lower remanence. Moreover, when the particle size D10 of the SmFeN-based magnetic powder is more than 3 μm, the coercive force of the bonded magnet tends to decrease. The D10 is determined by measuring a cumulative particle size distribution by volume using a laser diffraction particle size distribution analyzer (HELOS, Japan Laser Corporation) and is defined as the particle size corresponding to the 10th percentile of the cumulative undersize particle size distribution. The D50 and D90 described later are measured using the same device and defined as the 50th and 90th percentile particle sizes, respectively, corresponding to the 50th and 90th percentiles of the cumulative undersize particle size distribution.

The particle size D50 of the SmFeN-based magnetic powder is preferably at least 2.5 μm but not more than 5 μm, more preferably at least 2.7 μm but not more than 4.8 μm. When the particle size D50 of the SmFeN-based magnetic powder is at least 2.5 μm, a decrease in the remanence of the magnetic powder in the bonded magnet tends to be reduced. When the D50 is not more than 5 μm, a decrease in the coercive force of the bonded magnet tends to be reduced. The effect caused by the SmFeN-based magnetic powder having a particle size D50 within the range indicated above tends to be more significant when the SmFeN-based magnetic powder is anisotropic.

The particle size D90 of the SmFeN-based magnetic powder is preferably at least 3 μm but not more than 7 μm, more preferably at least 4 μm but not more than 6 μm. When the D90 is less than 3 μm, the amount of the magnetic powder filled in the bonded magnet tends to be reduced, resulting in lower magnetization. When the D90 is more than 7 μm, the coercive force of the bonded magnet tends to decrease.

The particle size distribution of the SmFeN-based magnetic powder defined by the equation below is preferably not more than 2.5, more preferably not more than 2, still more preferably not more than 1.5. When the particle size distribution is within the range indicated above, the bonded magnet with the SmFeN-based magnetic powder tends to have a higher coercive force. When the particle size distribution is not more than 2, the bonded magnet tends to have a much higher coercive force.

Particle size distribution=(D90−D10)/D50

In the step of obtaining of a magnetic powder-containing resin composition by kneading the magnetic powder, the thermosetting resin, and the curing agent at a temperature of higher than 70° C. but not higher than 140° C. and then lowering the temperature, the amount (filling ratio) of the magnetic powder is preferably at least 50% by volume but not more than 99.9% by volume, more preferably at least 55% by volume but not more than 90% by volume, still more preferably at least 60% by volume but not more than 85% by volume of the magnetic powder-containing resin composition in order to obtain a bonded magnet with a high remanence. When the filling ratio of the magnetic powder is within the range indicated above, the resulting bonded magnet can have a higher remanence. Moreover, when the filling ratio of the magnetic powder is at least 60% by volume, the kneading stability-improving effect of the present disclosure may be further increased, and at the same time the resulting bonded magnet may have better magnetic properties due to the high filling ratio. Here, when the magnetic powder is subjected to the above-described silica treatment or silane coupling treatment, the filling ratio refers to the filling ratio of the silica-treated or silane coupling-treated magnetic powder.

### Thermosetting Resin

Examples of the thermosetting resin include epoxy resins, phenol resins, urea resins, melamine resins, guanamine resins, unsaturated polyester resins, vinyl ester resins, diallyl phthalate resins, polyurethane resins, silicone resins, polyimide resins, alkyd resins, furan resins, dicyclopentadiene resins, acrylic resins, and allyl carbonate resins.

The thermosetting resin may include a thermosetting monomer having a melting point that is higher than 70° C. but not higher than 140° C. The term “thermosetting monomer” refers to a thermosetting resin which has one repeating unit. Here, when a curing agent monomer is present as a curing agent as described later, the thermosetting resin does not necessarily have to include a thermosetting monomer.

The thermosetting monomer is crystalline and has a melting point. The melting point is higher than 70° C. but not higher than 140° C., preferably at least 80° C. but not higher than 130° C., more preferably at least 90° C. but not higher than 125° C. When the melting point of the thermosetting monomer is higher than 70° C., the viscosity increase during kneading tends to be reduced as significantly high heat-curing reactivity may be inhibited. When the melting point is not higher than 140° C., the heat-curing reaction during kneading tends to be reduced as a low temperature may be used as the temperature during kneading.

Examples of the thermosetting monomer having a melting point that is higher than 70° C. but not higher than 140° C. include epoxy resins, phenolic resins, and urethane resins. Epoxy resins are preferred among these. Preferred are epoxy resins having a phenyl group in their structure, such as aryl-containing epoxy resins, biphenyl-containing epoxy resins, and bisphenol-containing epoxy resins. Biphenyl-containing epoxy resins and bisphenol-containing epoxy resins are preferred among these. Specific examples of the biphenyl-containing epoxy resins include YX4000 and YX4000K (Mitsubishi Chemical Corporation). Specific examples of the bisphenol-containing epoxy resins include YSLV-70XY and YSLV-80XY (NIPPON STEEL Chemical & Material Co., Ltd., melting point: about 80° C.). The thermosetting monomer having a melting point that is higher than 70° C. but not higher than 140° C. is preferably a bifunctional one.

The thermosetting resin may combine the thermosetting monomer having a melting point that is higher than 70° C. but not higher than 140° C. with another thermosetting resin. Examples of such other thermosetting resins include thermosetting monomers having a melting point that is not higher than 70° C. or of higher than 140° C., thermosetting oligomers, thermosetting polymers, and amorphous thermosetting resins. The thermosetting oligomers, thermosetting polymers, and amorphous thermosetting resins refer to thermosetting resins which have two or more repeating units and do not have a melting point. Examples of the thermosetting oligomers include epoxy resins, phenolic resins, and urethane resins, with epoxy resins being preferred. Examples of the epoxy resins include aryl-containing epoxy resins, aralkyl-containing epoxy resins, alkenyl-containing epoxy resins, alkyl-containing epoxy resins, and polyfunctional epoxy resins (novolac-containing epoxy resins). Polyfunctional epoxy resins are preferred among these. Preferred among the polyfunctional epoxy resins are cresol novolac-containing epoxy resins, trisphenol methane-containing epoxy resins, dicyclopentadiene-containing epoxy resins, naphthalene-containing epoxy resins, and phenol biphenylene-containing epoxy resins. More preferred are trisphenol methane-containing epoxy resins. Specific examples of the trisphenol methane-containing epoxy resins include EPPN-201 (Nippon Kayaku Co., Ltd.). The use of a polyfunctional epoxy resin can increase the heat resistance of the cured product.

### Curing Agent

Any curing agent that can heat-cure a thermosetting resin may be used. When the thermosetting resin used is an epoxy resin, examples of the curing agent include amine curing agents, acid anhydride curing agents, polyamide curing agents, imidazole curing agents, phenol resin curing agents, polymercaptan resin curing agents, polysulfide resin curing agents, and organic acid hydrazide curing agents.

The curing agent may include a curing agent monomer having a melting point that is higher than 70° C. but not higher than 140° C. The term “curing agent monomer” refers to a curing agent which has one repeating unit. Here, when a thermosetting monomer is present as a thermosetting resin as described above, the curing agent does not necessarily have to include a curing agent monomer.

The curing agent monomer is crystalline and has a melting point. The melting point is higher than 70° C. but not higher than 140° C., preferably at least 80° C. but not higher than 130° C., more preferably at least 90° C. but not higher than 125° C. When the melting point is higher than 70° C., the viscosity increase during kneading tends to be reduced as significantly high heat-curing reactivity may be inhibited. When the melting point is not higher than 140° C., the heat-curing reaction during kneading tends to be reduced as a low temperature may be used as the temperature during kneading.

Examples of the curing agent monomer having a melting point that is higher than 70° C. but not higher than 140° C. include phenolic curing agent monomers such as aryl-containing phenolic curing agents, aralkyl-containing phenolic curing agents, alkenyl-containing phenolic curing agents, and alkyl-containing phenolic curing agents, and amine curing agents such as aromatic amine curing agents and aliphatic amine curing agents. Amine curing agent monomers are preferred among these, with aromatic amine curing agents being more preferred. Specific examples of the aromatic amine curing agents include Bisaniline-M (Mitsui Fine Chemicals, Inc., melting point: about 115° C.) and diaminodiphenylmethane (Mitsui Fine Chemicals, Inc., MDA-100, melting point: about 92° C.). The curing agent monomer having a melting point that is higher than 70° C. but not higher than 140° C. is preferably a polyfunctional one, more preferably a bifunctional one.

The curing agent may combine the curing agent monomer having a melting point that is higher than 70° C. but not higher than 140° C. with another curing agent. Examples of such other curing agents include curing agent monomers having a melting point that is not higher than 70° C. or of higher than 140° C., curing agent oligomers, curing agent polymers, and amorphous curing agents. The curing agent oligomers, curing agent polymers, and amorphous curing agents refer to thermosetting resins which have two or more repeating units and do not have a melting point. Examples of the curing agent oligomers include phenol resin curing agents and polyamide curing agents. Phenol resin curing agents are preferred among these. Examples of such phenol resins include aryl-containing phenol resins, aralkyl-containing phenol resins, alkyl-containing phenol resins, and polyfunctional phenol resins (novolac-containing phenol resins). Polyfunctional phenol resins are preferred among these. Preferred among the polyfunctional phenol resins are cresol novolac-containing phenol resins, trisphenol methane-containing phenol resins, dicyclopentadiene-containing phenol resins, naphthalene-containing phenol resins, and phenol biphenylene-containing phenol resins. More preferred are trisphenol methane-containing phenol resins. Specific examples of the trisphenol methane-containing phenol resins include MEH-7500 (Meiwa Plastic Industries, Ltd.). The use of a polyfunctional phenol resin can increase the heat resistance of the cured product.

### Amount Ratio

In the step of preparing magnetic powder, a thermosetting resin, and a curing agent, the combined amount of thermosetting monomers having a melting point that is higher than 70° C. but not higher than 140° C. and curing agent monomers having a melting point that is higher than 70° C. but not higher than 140° C. is at least 33% by volume but not more than 100% by volume, preferably at least 40% by volume but not more than 90% by volume, more preferably at least 50% by volume but not more than 80% by volume, of the combined amount of the thermosetting resin and the curing agent. In this preparation step, the above-mentioned combined amount may be satisfied by either or both of the thermosetting monomer having a melting point that is higher than 70° C. but not higher than 140° C. and the curing agent monomer having a melting point that is higher than 70° C. but not higher than 140° C. Thus, it is not necessary to use both of them, and it is preferred to use at least the thermosetting monomer having a melting point that is higher than 70° C. but not higher than 140° C.

When the combined amount of the thermosetting and curing agent monomers having a specific melting point is at least 33% by volume in the step of preparing magnetic powder, a thermosetting resin, and a curing agent, the viscosity increase due to the progress of a curing reaction can be prevented during kneading of a mixture of the magnetic powder, the thermosetting resin, and the curing agent. As a result, kneading stability can be improved, and the efficiency of filling the mold cavity with the magnetic powder-containing resin composition in transfer molding can be enhanced. When the combined amount is less than 33% by volume, the viscosity tends to increase during kneading, and the efficiency of filling the mold cavity tends to decrease. Moreover, when the combined amount is not more than 90% by volume, the time required for heat-curing tends to be shortened, and this effect tends to be more significant when the combined amount is not more than 80% by volume. Moreover, in the step of obtaining of a magnetic powder-containing resin composition by kneading the magnetic powder, the thermosetting resin, and the curing agent at a temperature of higher than 70° C. but not higher than 140° C. and then lowering the temperature, when the filling ratio of the magnetic powder is more than 62% by volume of the magnetic powder-containing resin composition, if the thermosetting resin and the curing agent consist only of the thermosetting and curing agent monomers having a specific melting point, the magnetic powder and the resin may separate from each other so that they are not kneadable. Thus, to further increase the filling ratio of the magnetic powder, the combined amount of the thermosetting and curing agent monomers having a specific melting point is preferably not more than 90% by volume, more preferably not more than 80% by volume.

The amount of the thermosetting resin based on the combined amount of the magnetic powder, thermosetting resin, and curing agent is preferably at least 8% by volume but not more than 40% by volume. To ensure fluidity, the amount is more preferably at least 15% by volume but not more than 30% by volume. The amount of the curing agent based on the combined amount of the magnetic powder, thermosetting resin, and curing agent is preferably at least 2% by volume but not more than 22% by volume, more preferably at least 8% by volume but not more than 15% by volume. When the amount of the thermosetting resin based on the combined amount of the magnetic powder, thermosetting resin, and curing agent is at least 8% by volume, the fluidity during the production of a bonded magnet tends to be improved. When the amount is not more than 40% by volume, the filling ratio of the magnetic powder can be improved, and the resulting bonded magnet can have higher magnetic properties. Moreover, when the amount of the curing agent based on the combined amount of the magnetic powder, thermosetting resin, and curing agent is within the range indicated above, the progress of a curing reaction during kneading may be reduced in the production of the magnetic powder-containing resin composition.

### Optional Components

In the step of preparing magnetic powder, a thermosetting resin, and a curing agent, optional components, including, for example, resin additives such as a curing accelerator, a lubricant, an antioxidant, and a heavy metal deactivator, a thermoplastic resin, and an inorganic filler, may also be used.

Examples of the curing accelerator include imidazolium salts, phosphine compounds, phosphonium salts, imidazoles, amines, diazabicyclo compounds, phenol salts, and phenol novolac salts. The amount of the curing accelerator, if present, based on the combined amount of the magnetic powder, thermosetting resin, curing agent, and optional components is preferably at least 0.01% by volume but not more than 3% by volume.

Examples of the lubricant include zinc stearate, calcium behenate, calcium stearate, barium stearate, aluminum stearate, magnesium stearate, lithium stearate, sodium stearate, potassium stearate, sodium oleate, zinc laurate, calcium laurate, barium laurate, zinc linoleate, calcium linoleate, zinc 2-ethylhexanoate, lead benzoate, zinc p-tert-butylbenzoate, and barium p-tert-butylbenzoate. The amount of the lubricant, if present, based on the combined amount of the magnetic powder, thermosetting resin, curing agent, and optional components is preferably at least 0.01% by volume but not more than 1% by volume. When the amount of the lubricant is at least 0.01% by volume, the kneading stability of the resin composition can be increased. Moreover, when the amount of the lubricant is not more than 1% by volume, the filling ratio of the magnetic powder can be increased, and the resulting bonded magnet can have enhanced magnetic properties.

Examples of the antioxidant include phosphorus antioxidants, phenolic antioxidants, and sulfur antioxidants. The amount of the antioxidant, if present, based on the combined amount of the magnetic powder, thermosetting resin, curing agent, and optional components is preferably at least 0.01% by volume but not more than 1% by volume.

Examples of the thermoplastic resin include polyamides and elastomers. The blending with the thermoplastic resin can improve the mechanical properties of the cured product. The mass ratio of the thermosetting resin and the thermoplastic resin, if present, is preferably in the range of 99:1 to 80:20. In view of impact resistance, the mass ratio is more preferably in the range of 95:5 to 90:10.

Examples of the inorganic filler include talc and silica. The amount of the inorganic filler, if present, based on the combined amount of the magnetic powder, thermosetting resin, curing agent, and optional components is preferably at least 1% by volume but not more than 20% by volume.

### Kneading

After the step of preparing magnetic powder, a thermosetting resin, and a curing agent, a magnetic powder-containing resin composition may be obtained by kneading the magnetic powder, the thermosetting resin, and the curing agent at a temperature of higher than 70° C. but not higher than 140° C. and then lowering the temperature.

The magnetic powder, thermosetting resin, and curing agent may be kneaded by any method, such as using a kneading machine such as a single-screw kneading machine, a twin-screw kneading machine, or a kneader. The temperature during kneading is higher than 70° C. but not higher than 140° C., preferably at least 75° C. but not higher than 135° C., more preferably at least 80° C. but not higher than 130° C. At a temperature of not higher than 70° C., the thermosetting resin and the curing agent tend not to sufficiently melt, resulting in insufficient dispersion of the magnetic powder. At a temperature of higher than 140° C., the viscosity tends to increase due to the progress of a curing reaction. Also, in view of the balance between the degree of dispersion of the magnetic powder and the reduction of the viscosity increase, the kneading time at the temperature is preferably at least one minute but not longer than 10 minutes, more preferably at least three minutes but not longer than six minutes. After the kneading at the temperature, the temperature may be lowered. For example, the lowered temperature may be room temperature.

### Method of Producing Tablet for Transfer Molding

A method of producing a tablet for transfer molding according to the present embodiments includes: obtaining a magnetic powder-containing resin composition by the above-described production method; obtaining a ground product by grinding the magnetic powder-containing resin composition; and compressing the ground product.

In the step of obtaining a ground product, the magnetic powder-containing resin composition obtained by the above-described production method may be ground. The grinding may be performed using an apparatus such as a ball mill, a high-speed mixer, or a mortar machine.

In the compression step, the ground magnetic powder-containing resin composition may be compressed. The compression may be performed by filling a mold with the ground product of the magnetic powder-containing resin composition and applying a pressure, e.g., of at least 2 MPa but not higher than 20 MPa.

The tablet obtained by the production method of the present embodiments has high kneading stability as well as a high mold-filling efficiency due to its low viscosity even at high temperatures, and thus can be suitably used as a tablet for transfer molding.

### Method of Producing Bonded Magnet

A method of producing a bonded magnet according to the present embodiments includes, for example: obtaining a tablet for transfer molding by the above-described production method; filling a mold with the tablet for transfer molding by softening the tablet; and heat-curing the filled tablet while applying magnetism in the mold.

In the filling step, a mold may be filled with the tablet for transfer molding by softening the tablet. The mold temperature (softening temperature) for softening the tablet for transfer molding is preferably higher than 80° C. but not higher than 200° C., more preferably at least 150° C. but not higher than 180° C. At a softening temperature within the range indicated above, sufficient fluidity tends to be ensured while reducing oxidation degradation of the molding material. The filling pressure for filling the mold with the softened tablet is preferably at least 5 MPa but not higher than 30 MPa, more preferably at least 5 MPa but not higher than 15 MPa. At a filling pressure within the range indicated above, the mold can be sufficiently filled with the softened tablet, so that the creation of burrs during transfer molding can be reduced while obtaining a desired shape. Moreover, in addition to the transfer molding described above, compression molding in which the molding pressure is higher than 200 MPa and reaches about 15,000 MPa is also used as a molding method using a thermosetting resin material. In the compression molding, even a highly viscous resin composition can be sufficiently filled due to the high molding pressure. Hence, the magnetic powder-containing resin composition according to the present embodiments can provide a higher effect, in terms of kneading stability, in transfer molding in which the pressure during molding (filling pressure) will be within the range as indicated above.

In the heat-curing step, the filled tablet may be heat-cured while applying magnetism in the mold. The heat treatment temperature for heat-curing is preferably at least 150° C., more preferably at least 160° C. The holding time at the heat treatment temperature for heat-curing is preferably at least 30 seconds, more preferably at least 60 seconds. The holding time at the heat treatment temperature is also preferably not longer than five minutes, more preferably not longer than three minutes.

In the heat-curing step, the easy axes of magnetization of the magnetic powder can be aligned (oriented) by performing heat-curing while applying a magnetic field. The orientation field may be generated using an electromagnet or permanent magnet, and the magnitude of the magnetic field is preferably at least 4 kOe, more preferably at least 6 kOe.

After the heat-curing, the cured product may be taken out of the mold and optionally magnetized with an air-core coil or a magnetizing yoke. Thus, a bonded magnet can be obtained. The magnitude of the magnetizing field is preferably at least 20 kOe, more preferably at least 30 kOe.

### EXAMPLES

### 1. Production of Magnetic Powder

### Production Example 1

An amount of 5.0 kg of FeSO₄·7H₂O was mixed and dissolved in 2.0 kg of pure water. To the mixture were further added 0.49 kg of Sm₂O₃ and 0.74 kg of 70% sulfuric acid, and they were well stirred and completely dissolved. Next, pure water was added to the resulting solution so that the final Fe and Sm concentrations were adjusted to 0.726 mol/L and 0.112 mol/L, respectively, thereby obtaining a Sm—Fe sulfate solution.

### Precipitation Step

The entire amount of the prepared Sm—Fe sulfate solution was added dropwise with stirring to 20 kg of pure water kept at a temperature of 40° C. over 70 minutes from the start of the reaction, while simultaneously dropwise adding a 15% ammonia aqueous solution to adjust the pH to 7 to 8. Thus, a slurry containing a Sm—Fe hydroxide was obtained. The slurry was washed with pure water by decantation. Then, solid-liquid separation was performed to separate the hydroxide. The separated hydroxide was dried in an oven at 100° C. for 10 hours.

### Oxidation Step

The hydroxide obtained in the precipitation step was fired in the air at 1000° C. for one hour. After cooling, a red Sm—Fe oxide as raw material powder was obtained.

### Pretreatment Step

An amount of 100 g of the Sm—Fe oxide was put in a steel container to a thickness of 10 mm. The container was placed in a furnace, and the pressure was reduced to 100 Pa. Then, while introducing hydrogen gas, the temperature was increased to a pretreatment temperature of 850° C. and maintained at this temperature for 15 hours. The oxygen concentration was measured by non-dispersive infrared spectroscopy (ND-IR) (EMGA-820, Horiba, Ltd.), and it was found to be 5% by mass. The results show that a black partial oxide was obtained in which the oxygen bonded to Sm remained unreduced while 95% of the oxygen bonded to Fe was reduced.

### Reduction Step

An amount of 60 g of the partial oxide obtained in the pretreatment step was mixed with 19.2 g of metallic calcium having an average particle size that is about 6 mm, and the mixture was placed in a furnace. After vacuum evacuation of the furnace, argon gas (Ar gas) was introduced into the furnace. The temperature was increased to 1045° C. and maintained for 45 minutes to obtain Fe—Sm alloy particles.

### Nitridation Step

Subsequently, the temperature inside the furnace was lowered to 100° C., followed by vacuum evacuation. Then, while introducing nitrogen gas, the temperature was increased to 450° C. and maintained at this temperature for 23 hours to obtain a magnetic particle-containing bulk product.

### Water Washing Step

The bulk product obtained in the nitridation step was introduced into 3 kg of pure water and stirred for 30 minutes. After standing still, the supernatant was drained by decantation. The introduction into pure water, stirring, and decantation were repeated 10 times. Next, 2.5 g of 99.9% acetic acid was introduced and stirred for 15 minutes. After standing still, the supernatant was drained by decantation. The introduction into pure water, stirring, and decantation were repeated twice, followed by dehydration, drying, and then mechanical crushing to obtain SmFeN-based magnetic powder (average particle size (D50) about 3 μm).

### Phosphate Treatment Step

A phosphate treatment liquid was prepared by mixing 85% orthophosphoric acid, sodium dihydrogen phosphate, and sodium molybdate dihydrate at a mass ratio of 1:6:1, respectively, and adding pure water and dilute hydrochloric acid to adjust the pH and the PO₄ concentration to 2.5 and 20% by mass, respectively. An amount of 1000 g of the SmFeN-based magnetic powder obtained in the water washing step was stirred in dilute hydrochloric acid containing 70 g of hydrogen chloride for one minute to remove the oxidized surface film and contaminants, followed by repeating draining and filling of water until the supernatant had a conductivity of not higher than 100 μS/cm. Thus, a slurry containing 10% by mass of the SmFeN-based magnetic powder was obtained. While stirring the slurry, 100 g of the prepared phosphate treatment liquid was entirely introduced into the treatment tank. Thereafter, the phosphating reaction slurry was maintained for 30 minutes while introducing 6% by mass hydrochloric acid as needed to control the pH of the slurry within the range of 2.5±0.1. Next, the resulting slurry was subjected to suction filtration, dehydration, and vacuum drying to obtain phosphate-coated SmFeN-based magnetic powder (remanence Br: 13.0 kG, coercive force iHc: 19.8 kOe, average particle size: 3.32 μm, D10: 1.59 μm, D50: 3.24 μm, D90: 5.15 μm, particle size distribution: 1.10).

### Production Example 2

The same process up to the phosphate treatment step as in Production Example 1 was performed to obtain magnetic powder. Then, the magnetic powder was further subjected to a below-described oxidation step after phosphate treatment to obtain magnetic powder of Production Example 2.

### Oxidation Step after Phosphate Treatment

The temperature of 1000 g of the phosphate-coated SmFeN-based magnetic powder was gradually increased in an atmosphere of a gas mixture of nitrogen and air (oxygen concentration: 4%, 5 L/min) from room temperature to a maximum temperature of 200 ° C., at which heat treatment was performed for eight hours to obtain oxidized SmFeN-based magnetic powder (remanence Br: 13.0 kG, coercive force iHc: 20.2 kOe, average particle size: 3.34 μm, D10: 1.60 μm, D50: 3.28 μm, D90: 5.22 μm, particle size distribution: 1.11).

### Production Example 3

The same process up to the water washing step as in Production Example 1 was performed to obtain magnetic powder. A phosphate treatment liquid was prepared by mixing 85% orthophosphoric acid, sodium dihydrogen phosphate, and sodium molybdate dihydrate at a mass ratio of 1:6:1, respectively, and adding pure water and dilute hydrochloric acid to adjust the pH and the PO₄ concentration to 2.5 and 20% by mass, respectively. An amount of 1000 g of the SmFeN-based magnetic powder obtained in the water washing step was stirred in dilute hydrochloric acid containing 70 g of hydrogen chloride for one minute to remove the oxidized surface film and contaminants, followed by repeating draining and filling of water until the supernatant had a conductivity of not higher than 100 μS/cm. Thus, a slurry containing 10% by mass of the SmFeN-based magnetic powder was obtained. While stirring the slurry, 100 g of the prepared phosphate treatment liquid was entirely introduced into the treatment tank. The pH of the phosphating reaction slurry rose from 2.5 to 6 over 5 minutes. After stirring for 15 minutes, the resulting slurry was subjected to suction filtration, dehydration, and vacuum drying to obtain phosphate-coated SmFeN-based magnetic powder (remanence Br: 13.1 kG, coercive force iHc: 15.2 kOe, average particle size: 3.37 μm, D10: 1.63 μm, D50: 3.28 μm, D90: 5.22 μm, particle size distribution: 1.09).

### Production Example 4

### Reduction Step 2

A crucible was charged with a powder mixture of 52.5 g of iron powder having an average particle size (D50) of about 50 μm, 21.3 g of samarium oxide powder having an average particle size (D50) of 3 μm, and 10.5 g of metallic calcium, and then placed in a furnace. After vacuum evacuation of the furnace, argon gas (Ar gas) was introduced into the furnace. The temperature was increased to 1150° C. and maintained for five hours to obtain Fe—Sm alloy particles.

### Nitridation Step 2

Subsequently, the Fe—Sm alloy particles were heat-treated in an ammonium/hydrogen gas mixture at 420° C. for 23 hours to obtain a magnetic particle-containing bulk product.

### Water Washing Step 2

The bulk product obtained in the nitridation step was introduced into 3 kg of pure water and stirred for 30 minutes. After standing still, the supernatant was drained by decantation. The introduction into pure water, stirring, and decantation were repeated 10 times. Next, 2.5 g of 99.9% acetic acid was introduced and stirred for 15 minutes. After standing still, the supernatant was drained by decantation. The introduction into pure water, stirring, and decantation were repeated twice. Then, dehydration and drying were performed to obtain SmFeN-based magnetic powder (D50: 30 μm).

### Phosphate Treatment Step 2

An amount of 15 g of the obtained magnetic powder, 0.44 g of an 85% orthophosphoric acid aqueous solution, 100 mL of isopropanol (IPA), and 200 g of alumina beads with a diameter of 10 mm were sealed in a glass bottle and then ground using a vibration ball mill for 120 minutes. Subsequently, the slurry was filtered and then vacuum dried at 100° C. to obtain phosphate-coated SmFeN-based magnetic powder (remanence Br: 11.5 kG, coercive force iHc: 12.3 kOe, average particle size: 3.96 μm, D10: 0.98 μm, D50: 3.12 μm, D90: 7.74 μm, particle size distribution: 2.17).

### Evaluation of Magnetic Powder

### Remanence (Br) and Coercive Force (iHc) of Magnetic Powder

The magnetic properties (residual magnetization σr, and intrinsic coercive force iHc) of the phosphate-coated SmFeN-based magnetic powder obtained in Production Examples 1 to 4 were measured using a vibrating sample magnetometer (VSM, Riken Denshi Co., Ltd., model: BHV-55). The remanence Br (unit: kG) was also calculated from the residual magnetization σr (unit: emu/g) using the equation: Br=4×π×ρ×σr, where ρ: density=7.66 g/cm³. Table 1 shows the results.

### DSC Exothermic Onset Temperature

The exothermic onset temperature was measured by weighing 20 mg of each of the phosphate-coated SmFeN-based magnetic powder obtained in Production Examples 1 to 4, and subjecting it to DSC analysis using a high-temperature differential scanning calorimeter (DSC6300, Hitachi High-Tech Science Corporation) under measurement conditions including an air atmosphere (200 mL/min), a temperature rise from room temperature to 400° C. (rate of temperature rise: 20° C./min), and alumina (20 mg) as reference. Table 1 shows the results of DSC analysis. A higher exothermic onset temperature indicates less heat generated by oxidation, meaning that a denser phosphate coating is formed.

### α-Fe Peak Height Ratio

The XRD patterns of the phosphate-coated SmFeN-based magnetic powder obtained in Production Examples 1 to 4 were measured using a powder X-ray crystal diffraction instrument (Rigaku Corporation, X-ray wavelength: CuKa1). Then, the diffraction peak intensity of the (110) plane of α-Fe was divided by the diffraction peak intensity of the (300) plane of Sm₂Fe₁₇N₃ and then multiplied by 10,000 to obtain a value as an α-Fe peak height ratio. Table 1 shows the results. A lower α-Fe peak height ratio means a smaller amount of α-Fe as an impurity.

### Amount of Attached PO₄

The phosphorus (P) concentrations of the phosphate-coated SmFeN-based magnetic powder obtained in Production Examples 1 to 4 were measured by ICP atomic emission spectroscopy (ICP-AES) and converted to a PO₄ molecule content to determine the amount of attached PO4. Table 1 shows the results.

### Total Carbon Content

The total carbon (TC) contents of the phosphate-coated SmFeN-based magnetic powder obtained in Production Examples 1 to 4 were measured using a combustion catalytic oxidation-type total organic carbon (TOC) analyzer (Shimadzu Corporation, model: SSM-5000A). Table 1 shows the results.

TABLE 1

| | | | | | | DSC | | | |
|---|---|---|---|---|---|---|---|---|---|
| | | pH adjustment | | | | exothermic | | | |
| | | during | | | | onset | Amount of | α-Fe peak | |
| | Treatment | phosphate | | Br | iHc | temperature | attached PO₄ | height ratio | TC |
| | medium | treatment | Oxidation | (kG) | (kOe) | (° C.) | (wt %) | (110/300) | (ppm) |
| Production | Water | 2.5 | No | 13.0 | 19.8 | 210.1 | 1.1 | 41 | 280 |
| Example 1 | | | | | | | | | |
| Production | Water | 2.5 | Yes | 13.0 | 20.2 | 220.3 | 1.1 | 34 | 180 |
| Example 2 | | | | | | | | | |
| Production | Water | No pH | No | 13.1 | 15.2 | 165.2 | 0.5 | 229 | 280 |
| Example 3 | | adjustment | | | | | | | |
| | | (2.5→6) | | | | | | | |
| Production | IPA | No pH | No | 11.5 | 12.3 | 100.6 | 1.7 | 259 | 1300 |
| Example 4 | | adjustment | | | | | | | |

As shown in Table 1, Production Example 1 in which pH adjustment was performed in an aqueous solvent during the phosphate treatment exhibited a higher coercive force (iHc) than Production Example 3 in which no pH adjustment was performed in an aqueous solvent. Production Example 4 in which no pH adjustment was performed in an isopropanol solvent exhibited the lowest coercive force.

### 2. Production of Magnetic Powder-Containing Resin Composition

### Example 1

### Silica Treatment

Magnetic powder 1 (SmFeN-based magnetic powder of Production Example 1), ethyl silicate 40, and a 12.5% by mass ammonia aqueous solution were mixed at a mass ratio of 97.8:1.8:0.4, respectively, using a mixer. The mixture was heated in vacuum at 200° C. to obtain magnetic powder 1 (silica-treated magnetic powder) provided with a silica thin film on the particle surface.

### Silane Coupling Treatment

Magnetic powder 1 provided with a silica thin film obtained above was mixed with a 12.5% by mass ammonia aqueous solution, and the mixture was mixed with a 50% by mass solution of γ-glycidoxypropyltriethoxysilane in ethanol in a mixer. The mass ratio of magnetic powder 1 provided with a silica thin film, the 12.5% by mass ammonia aqueous solution, and the solution of γ-glycidoxypropyltriethoxysilane in ethanol was 99.4:0.2:0.4, respectively. The resulting mixture was dried in a nitrogen atmosphere at 100° C. for 10 hours to obtain silane coupling-treated magnetic powder 1 (CP-treated magnetic powder).

### Kneading

According to the formulation shown in Table 2, the silane coupling-treated magnetic powder 1, the thermosetting resin, the curing agent, the curing accelerator, and the lubricant were weighed and kneaded. Next, the mixture was kneaded using a kneader (130° C., 10 rpm, retention time: six minutes) to obtain a magnetic powder-containing resin composition including magnetic powder and a thermosetting resin composition.

### Examples 2 to 7, Comparative Examples 1 to 7

A magnetic powder-containing resin composition including magnetic powder and a thermosetting resin composition was obtained by performing a silica treatment, a silane coupling treatment, and kneading as in Example 1, except that the magnetic powder used was changed as shown in Table 2. Here, in Comparative Examples 3 to 5, the respective magnetic powder of the production examples was mixed with another as shown in Table 2, and the particle sizes of the total magnetic powder were as follows: average particle size: 51.2 μm, D10: 2.07 μm, D50: 5.33 μm, D90: 51.2 μm, particle size distribution: 9.21.

| | Magnetic powder 1 (SmFeN) | | | | | | | | | | | |
|---|---|---|---|---|---|---|---|---|---|---|---|---|
| | | | | | | Filling ratio | Filling ratio | | | | | Total |
| | | | | | | (calculated | (calculated | Magnetic powder 2 (NdFeB) | | | | magnetic |
| | Magnetic | | | Average | | as silica- | as CP- | | | Average | | powder |
| | powder | | | particle | | treated | treated | | Filling | particle | | Filling |
| | production | Oxidation | iHc | size | D50 | powder) | powder) | iHc | ratio | size | D50 | ratio |
| | conditions | temperature | (kOe) | (μm) | (μm) | (vol %) | (vol %) | (kOe) | (vol %) | (μm) | (μm) | (vol %) |
| Ex. 1 | Production | — | 19.8 | 3.3 | 3.2 | 60 | 61.8 | — | — | — | — | 61.8 |
| | Example 1 | | | | | | | | | | | |
| Ex. 2 | Production | 200° C. | 20.2 | 3.3 | 3.3 | 60 | 61.8 | — | — | — | — | 61.8 |
| | Example 2 | | | | | | | | | | | |
| Ex. 3 | Production | 200° C. | 20.2 | 3.3 | 3.3 | 60 | 61.8 | — | — | — | — | 61.8 |
| | Example 2 | | | | | | | | | | | |
| Ex. 4 | Production | 200° C. | 20.2 | 3.3 | 3.3 | 60 | 61.8 | — | — | — | — | 61.8 |
| | Example 2 | | | | | | | | | | | |
| Ex. 5 | Production | 200° C. | 20.2 | 3.3 | 3.3 | 60 | 61.8 | — | — | — | — | 61.8 |
| | Example 2 | | | | | | | | | | | |
| Ex. 6 | Production | 200° C. | 20.2 | 3.3 | 3.3 | 60 | 61.8 | — | — | — | — | 61.8 |
| | Example 2 | | | | | | | | | | | |
| Ex. 7 | Production | 200° C. | 20.2 | 3.3 | 3.3 | 60 | 61.8 | — | — | — | — | 61.8 |
| | Example 2 | | | | | | | | | | | |
| Comp. | Production | 200° C. | 20.2 | 3.3 | 3.3 | 60 | 61.8 | — | — | — | — | 61.8 |
| Ex. 1 | Example 2 | | | | | | | | | | | |
| Comp. | Production | 200° C. | 20.2 | 3.3 | 3.3 | 60 | 61.8 | — | — | — | — | 61.8 |
| Ex. 2 | Example 2 | | | | | | | | | | | |
| Comp. | Production | 200° C. | 20.2 | 3.3 | 3.3 | 30 | 30.9 | 17.4 | 30.9 | 119 | 114 | 61.8 |
| Ex. 3 | Example 2 | | | | | | | | | | | |
| Comp. | Production | — | 15.2 | 3.4 | 3.3 | 30 | 30.9 | 17.4 | 30.9 | 119 | 114 | 61.8 |
| Ex. 4 | Example 3 | | | | | | | | | | | |
| Comp. | Production | — | 12.3 | 4.0 | 3.1 | 30 | 30.9 | 17.4 | 30.9 | 119 | 114 | 61.8 |
| Ex. 5 | Example 4 | | | | | | | | | | | |
| Comp. | — | — | — | — | — | — | — | 17.4 | 56.8 | 119 | 114 | 56.8 |
| Ex. 6 | | | | | | | | | | | | |
| Comp. | Production | 200° C. | 20.2 | 3.3 | 3.3 | 60 | 61.8 | — | — | — | — | 61.8 |
| Ex. 7 | Example 2 | | | | | | | | | | | |

| | | | | | Curing agent | | | | | |
|---|---|---|---|---|---|---|---|---|---|---|
| | | Thermosetting resin | | | | 1,12- | | | | |
| | | | | Diepoxy- | Bisaniline- | Diamino- | | | | Ratio of |
| | Total | YX4000 | EPPN-201 | octane | M | dodecane | MEH-7500 | | | monomer |
| | magnetic | (Melting | (No | (Melting | (Melting | (Melting | (No | Others | | components |
| | powder | point: | melting | point: | point: | point: | melting | Curing | | having |
| | Average | 105° C.) | point) | 7° C.) | 115° C.) | 70° C.) | point) | accelerator | Lubricant | specific |
| | particle | Filling | Filling | Filling | Filling | Filling | Filling | Filling | Filling | melting |
| | size | ratio | ratio | ratio | ratio | ratio | ratio | ratio | ratio | point |
| | (μm) | (vol %) | (vol %) | (vol %) | (vol %) | (vol %) | (vol %) | (vol %) | (vol %) | (vol %) |
| Ex. 1 | 3.3 | 24.6 | — | — | — | — | 12.4 | 0.7 | 0.5 | 67 |
| Ex. 2 | 3.3 | 24.5 | — | — | 12.5 | — | — | 0.7 | 0.5 | 100 |
| Ex. 3 | 3.3 | 24.5 | — | — | 6.7 | — | 5.8 | 0.7 | 0.5 | 84 |
| Ex. 4 | 3.3 | 24.6 | — | — | — | — | 12.4 | 0.7 | 0.5 | 67 |
| Ex. 5 | 3.3 | 19.8 | 4.9 | — | — | — | 12.3 | 0.7 | 0.5 | 53 |
| Ex. 6 | 3.3 | 14.9 | 9.8 | — | — | — | 12.3 | 0.7 | 0.5 | 40 |
| Ex. 7 | 3.3 | 12.4 | 12.3 | — | — | — | 12.3 | 0.7 | 0.5 | 33 |
| Comp. | 3.3 | 7.5 | 17.2 | — | — | — | 12.3 | 0.7 | 0.5 | 20 |
| Ex. 1 | | | | | | | | | | |
| Comp. | 3.3 | — | 24.7 | — | — | — | 12.3 | 0.7 | 0.5 | 0 |
| Ex. 2 | | | | | | | | | | |
| Comp. | 51.2 | 24.6 | — | — | — | — | 12.4 | 0.7 | 0.5 | 67 |
| Ex. 3 | | | | | | | | | | |
| Comp. | 51.2 | 24.6 | — | — | — | — | 12.4 | 0.7 | 0.5 | 67 |
| Ex. 4 | | | | | | | | | | |
| Comp. | 51.2 | 24.6 | — | — | — | — | 12.4 | 0.7 | 0.5 | 67 |
| Ex. 5 | | | | | | | | | | |
| Comp. | 118.5 | 27.9 | — | — | — | — | 14.1 | 0.7 | 0.5 | 67 |
| Ex. 6 | | | | | | | | | | |
| Comp. | 3.3 | 11.4 | — | 13.8 | — | 11.8 | — | 0.7 | 0.5 | 31 |
| Ex. 7 | | | | | | | | | | |

Ex.: Example
Comp. Ex.: Comparative Example

The details of the components shown in Table 2 are as follows.

(i) NdFeB magnetic powder (Magnetic powder 2)
MF-18P (Aichi Steel Corporation, remanence Br: 12.5 kG, coercive force iHc: 17.4 kOe, average particle size: 118.5 μm, D10: 47.1 μm, D50: 113.5 μm, D90: 197.6 μm, particle size distribution: 1.33)
(ii) Thermosetting resin
YX4000K (Mitsubishi Chemical Corporation, biphenyl-containing epoxy resin, melting point: 105° C.)
EPPN-201 (Nippon Kayaku Co., Ltd., triphenylmethane-containing epoxy resin, thermosetting oligomer)
Diepoxyoctane (Tokyo Chemical Industry Co., Ltd., melting point: 7° C.)
(iii) Curing agent
Bisaniline-M (Mitsui Fine Chemicals, Inc., melting point: 115° C.)
MEH-7500 (Meiwa Plastic Industries, Ltd., hydroxybenzaldehyde resin, curing agent oligomer)
1,12-Diaminododecane (Tokyo Chemical Industry Co., Ltd., melting point: 70° C.)
(iv) Curing accelerator

### Curezol 2PHZ-PW

### (v) Lubricant

calcium behenate

### Evaluation

### Kneading Stability, and Cure Time of Kneaded Mixture

The torque during the kneading was monitored to evaluate kneading stability. Moreover, 0.2 g of the kneaded mixture was kneaded on a hot plate heated at 180° C., while the time to completely cure (cure time) was measured. Table 3 shows the results.

### Fluidity of Bonded Magnet

The magnetic powder-containing resin composition was ground with a high-speed mill, and then a mold was filled with the resulting powdery composition, followed by compression at 0.5 MPa, thereby preparing a tablet (shape: φ14-T40). The tablet was put in a pot of a transfer molding machine and injected into a 3t bar-flow mold (cavity shape: W10×L70×t3) heated at 180° C. at an injection pressure of 10 MPa, an injection speed of 20 mm/s, and an orientation field of 6 kOe to cause curing, thereby obtaining a molded bonded magnet. The longitudinal dimension of the molded bonded magnet was measured to evaluate fluidity. Table 3 shows the results.

### Magnetic Properties and Heat Resistance of Bonded Magnet

The magnetic powder-containing resin composition was ground with a high-speed mill, and then a mold was filled with the resulting powdery composition, followed by compression at 0.5 MPa, thereby preparing a tablet (shape: φ14-T20). The tablet was put in a pot of a transfer molding machine and injected into a cylindrical mold (cavity shape: φ10×t7, external magnetic field: 6 kOe) heated at 180° C. at an injection pressure of 10 MPa and an injection speed of 20 mm/s to cause curing, thereby obtaining a molded bonded magnet. After the molded bonded magnet was magnetized with a 6 T field, the magnetic properties (intrinsic coercive force iHc, remanence Br) were measured using a BH tracer. Table 3 shows the results.

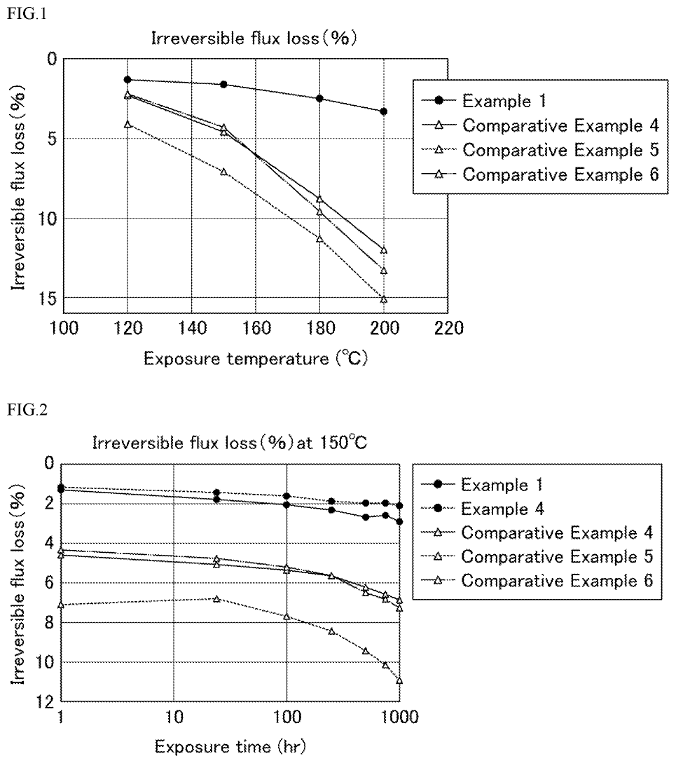

Moreover, the magnetized magnet was exposed to the atmosphere for one hour in an oven at a predetermined temperature of 120 to 200° C. The total fluxes of the magnet before and after the test were measured with a fluxmeter to evaluate the heat resistance (irreversible flux loss) of the magnet. The measurement at 150° C. was continued up to 1000 hours to evaluate the long-term heat resistance (irreversible flux loss). The irreversible flux loss was calculated by the following equation. FIGS. 1 and 2 show the results.

Irreversible flux loss (%)=(Total flux (at 0 hr)−Total flux (after predetermined time))/Total flux (at 0 hr)×100

TABLE 3

| | Kneading | Tablet | Magnet | | |
|---|---|---|---|---|---|
| | stability of | Cure time | Flow length | | |
| | kneaded mixture | Cure time | of magnet | Magnetic properties | |
| | Kneading torque | at 180° C. | Bar-flow length | Br of magnet | iHc of magnet |
| | (Nm) | (sec) | (mm) | (kOe) | (kOe) |
| Example 1 | 7.5 | 100 | 70 | 7.2 | 18.2 |
| Example 2 | 4.5 | 300 | 70 | 7.2 | 20.0 |
| Example 3 | 8.0 | 90 | 70 | 7.2 | 20.1 |
| Example 4 | 7.5 | 100 | 70 | 7.2 | 20.0 |
| Example 5 | 8.5 | 80 | 70 | 7.2 | 20.1 |
| Example 6 | 9.5 | 80 | 70 | 7.2 | 20.1 |
| Example 7 | 12.0 | 60 | 40 | 7.2 | 20.0 |
| Comparative | 16.0 | 30 | 0 | Unmoldable | Unmoldable |
| Example 1 | | | | | |
| Comparative | >20 Viscosity | 20 | 0 | Unmoldable | Unmoldable |
| Example 2 | increased | | | | |
| Comparative | 3.1 | 110 | 70 | 7.5 | 17.9 |
| Example 3 | | | | | |
| Comparative | 4.1 | 110 | 70 | 7.4 | 16.6 |
| Example 4 | | | | | |
| Comparative | 3.8 | 110 | 70 | 7.4 | 14.5 |
| Example 5 | | | | | |
| Comparative | 2.0 | 130 | 70 | 6.0 | 17.1 |
| Example 6 | | | | | |
| Comparative | >20 Viscosity | 20 | 0 | Unmoldable | Unmoldable |
| Example 7 | increased | | | | |

As shown in Table 3, the magnetic powder-containing resin compositions of Comparative Examples 1, 2, and 7, in which the ratio of the combined amount of thermosetting and curing agent monomers having a specific melting point was less than 33% by volume, had poor kneading stability and therefore could not be transfer-molded. The magnetic powder-containing resin compositions of Comparative Examples 3 to 6 provided bonded magnets with poor coercive force. As shown in FIGS. 1 and 2, the bonded magnets produced from the magnetic powder-containing resin compositions of Comparative Examples 4 to 6 had a high irreversible flux loss and poor heat resistance, while the bonded magnets of Examples 1 and 4 exhibited improved heat resistance. The magnetic powder-containing resin compositions of Examples 1 to 7 were excellent in kneading stability, the coercive force of the bonded magnet, and heat resistance.

What is claimed is:

1. A method of producing a magnetic powder-containing resin composition, the method comprising:
preparing at least one magnetic powder having an average particle size that is at least 1 μm but not more than 10 μm, at least one thermosetting resin, and at least one curing agent, wherein at least one of the thermosetting resin and the curing agent includes at least one monomer having a melting point that is higher than 70° C. but not higher than 140° C., and wherein an amount of the monomer having the melting point that is higher than 70° C. but not higher than 140° C. is at least 33% by volume but not more than 100% by volume of a combined amount of the thermosetting resin and the curing agent; and
obtaining the magnetic powder-containing resin composition by kneading the magnetic powder, the thermosetting resin, and the curing agent at a temperature of higher than 70° C. but not higher than 140° C. and then lowering the temperature.

2. The method according to claim 1,
wherein, in the preparing, the thermosetting resin includes a thermosetting monomer having a melting point that is higher than 70° C. but not higher than 140° C.

3. The method according to claim 2,
wherein, in the preparing, the thermosetting monomer comprises an epoxy resin.

4. The method according to claim 3,
wherein the epoxy resin is a biphenyl-containing epoxy resin or a bisphenol-containing epoxy resin.

5. The method according to claim 2,
wherein, in the preparing, an amount of the thermosetting monomer having the melting point that is higher than 70° C. but not higher than 140° C. is at least 33% by volume but not more than 100% by volume of the combined amount of the thermosetting resin and the curing agent.

6. The method according to claim 2,
wherein, in the preparing, the curing agent includes a curing agent monomer having a melting point that is higher than 70° C. but not higher than 140° C.

7. The method according to claim 6,
wherein, in the preparing, the curing agent monomer comprises an aromatic amine curing agent.

8. The method according to claim 6,
wherein, in the preparing, the curing agent monomer is an aromatic amine curing agent.

9. The method according to claim 6,
wherein, in the preparing, a combined amount of the thermosetting monomer having the melting point that is higher than 70° C. but not higher than 140° C. and the curing agent monomer having the melting point that is higher than 70° C. but not higher than 140° C. is at least 33% by volume but not more than 100% by volume of the combined amount of the thermosetting resin and the curing agent.

10. The method according to claim 1,
wherein, in the obtaining of the magnetic powder-containing resin composition, an amount of the magnetic powder is at least 50% by volume but not more than 99.9% by volume of the magnetic powder-containing resin composition.

11. The method according to claim 1,
wherein, in the preparing, the magnetic powder comprises a SmFeN-based magnetic powder.

12. The method according to claim 11,
wherein the SmFeN-based magnetic powder has a particle size distribution, (D90−D10)/D50, that is not more than 2.5.

13. The method according to claim 11,
wherein, in the preparing, the SmFeN-based magnetic powder has a phosphate content that is higher than 0.5% by mass but not higher than 4.5% by mass and a carbon content that is not higher than 800 ppm.

14. A method of producing a tablet for transfer molding, the method comprising:
obtaining a magnetic powder-containing resin composition by the method according to claim 1;
obtaining a ground product by grinding the magnetic powder-containing resin composition; and
compressing the ground product.

15. A method of producing a bonded magnet, the method comprising:
obtaining a tablet for transfer molding by the method according to claim 14;
filling a mold with the tablet for transfer molding by softening the tablet; and
heat-curing the filled tablet while applying magnetism in the mold.

16. The method according to claim 15,
wherein, in the heat-curing, a heat treatment temperature is at least 150° C.

17. The method according to claim 16,
wherein, in the heat-curing, a holding time at the heat treatment temperature is at least 30 seconds.

18. The method according to claim 16,
wherein, in the heat-curing, a holding time at the heat treatment temperature is not longer than five minutes.

19. The method according to claim 15,
wherein, in the filling, a filling pressure is at least 5 MPa but not higher than 30 MPa.
